(19) United States
(12) Patent Application Publication
(10) Pub. No.: US 2025/0145057 A1
(43) Pub. Date: May 8, 2025

(54) SEAT CONTROL APPARATUS AND METHOD

(71) Applicants: HYUNDAI MOTOR COMPANY, Seoul (KR); KIA CORPORATION, Seoul (KR)

(72) Inventor: Seung Su Han, Seoul (KR)

(73) Assignees: HYUNDAI MOTOR COMPANY, Seoul (KR); KIA CORPORATION, Seoul (KR)

(21) Appl. No.: 18/596,374

(22) Filed: Mar. 5, 2024

(30) Foreign Application Priority Data
Nov. 6, 2023 (KR) 10-2023-0151992

(51) Int. Cl. B60N 2/02

(52) U.S. Cl. CPC B60N 2/0268

(57) ABSTRACT

A seat control apparatus and method are disclosed. The seat control apparatus identifies whether a state of a rear seat passenger is a first specified state when it is identified that the rear seat passenger is seated on a rear seat. The apparatus identifies whether a state of a user seated on a front seat is a second specified state indicative of carelessness when the passenger seated on the rear seat is in the first specified state. The apparatus determines a control parameter including slide movement amounts of the front seat and/or the rear seat and/or a swivel direction of the front seat based on first body information of the rear seat passenger and second body information of the user when the user is in the second specified state. The apparatus provides the user with seat control information including the determined control parameter.

### CROSS-REFERENCE TO RELATED APPLICATION

This application claims the benefit of and priority to Korean Patent Application No. 10-2023-0151992, filed in the Korean Intellectual Property Office on Nov. 6, 2023, the entire contents of which are incorporated herein by reference.

### TECHNICAL FIELD

The present disclosure relates to a seat control apparatus and method More particularly, the present disclosure relates to a technology for performing a slide and/or swivel control of at least one seat included in a host vehicle.

### BACKGROUND

Various components in an interior of a vehicle may be operatively connected to each other. The vehicle may include, for example, a seat control apparatus that may quickly and accurately provide various functions by performing cooperative controls between the components in the interior of the vehicle for convenience of users.

For example, a host vehicle may include a seat that may move (e.g., slide) forwards and rearwards in a fully automatic scheme with respect to a front side of the host vehicle. The seats may be automatically moved to a specified location when a situation, such as a single user input (e.g., a switch input) and/or occurrence of a specified event (e.g., a door opening or closing situation), is identified.

As another example, the host vehicle may include a seat that may be rotated 360 degrees. The rotation of the seat in place may be defined as a swivel. The seat control apparatus may perform a swivel control of the seat in a specified direction (e.g., the clockwise or counterclockwise).

In a situation in which an infant or a toddler is seated in an interior of the host vehicle, an emergency event, such as a situation in which the infant or the toddler needs the care of an adult, may occur. In some cases, when the infant or the toddler is seated in the rear seat, a situation in which the user seated in the front seat is not aware of this emergency event may occur.

### SUMMARY

The present disclosure has been made to solve the above-mentioned problems occurring in the prior art while advantages achieved by the prior art are maintained intact.

Aspects of the present disclosure provide a seat control apparatus and method in which an emergency situation may be quickly recognized. The apparatus and method may provide a user with a pop-up notification that a front seat is to be swiveled in a situation in which a user seated on the front seat is not aware of an emergency situation of a rear seat passenger (e.g., an infant or a toddler) seated on a rear seat.

Aspects of the present disclosure also provide a seat control apparatus and method that may store body information of a user in a memory. The seat control apparatus and method may determine a movement amount of a front seat based on the body information stored in the memory when an emergency situation is identified.

Aspects of the present disclosure also provide a seat control apparatus and method in which a swivel control of a front seat may be performed more easily by determining a movement amount of a steering wheel (i.e., an amount by which the steering wheel is to be moved) based on body information of a user.

Aspects of the present disclosure also provide a seat control apparatus and method that may provide convenient usage to a user by determining a swivel direction of a front seat based on a seating state (e.g., a seating location, a seating direction, a seating posture, and/or a volume) of a rear seat passenger.

The technical problems to be solved by the present disclosure are not limited to the aforementioned problems. Other technical problems not mentioned herein should be more clearly understood from the following description by those having ordinary skill in the art to which the present disclosure pertains.

According to an aspect of the present disclosure, a seat control apparatus is provided. The seat control apparatus includes a sensor part, a driving part, and a memory that stores one or more instructions. The apparatus further includes a controller operatively connected to the sensor part, the driving part, and the memory. The one or more instructions, when executed by the controller, cause the seat control apparatus to, when it is identified by using the sensor part that a rear seat passenger is seated on a rear seat, identify whether a state of the rear seat passenger corresponds to a first specified state. The one or more instructions, when executed by the controller, also cause the seat control apparatus to, when the rear seat passenger seated on the rear seat is in the first specified state, identify whether a state of a user seated on a front seat corresponds to a second specified state indicative of carelessness. The one or more instructions, when executed by the controller, further cause the seat control apparatus to, when the user is in the second specified state, determine a control parameter including at least one of a slide movement amount of the front seat, a slide movement amount of the rear seat, a swivel direction of the front seat, or a combination thereof, based on first body information of the rear seat passenger and second body information of the user. The one or more instructions, when executed by the controller, additionally cause the seat control apparatus to provide the user with seat control information including the determined control parameter.

In an embodiment, the instructions, when executed by the controller, may cause the seat control apparatus to identify that the state of the rear seat passenger corresponds to the first specified state when it is identified that care is required for the rear seat passenger based on information on a feeling state of the rear seat passenger acquired by using the sensor part.

In an embodiment, the instructions, when executed by the controller, may cause the seat control apparatus to identify that the state of the rear seat passenger corresponds to the first specified state when it is identified that the rear seat passenger corresponds is a child of a specific age or less based on the first body information of the rear seat passenger acquired by using the sensor part.

In an embodiment, the instructions, when executed by the controller, may cause the seat control apparatus to identify that the state of the user corresponds to the second specified state when it is identified that the user is in a carelessness state based on gaze information of the user acquired by using the sensor part.

In an embodiment, the instructions, when executed by the controller, may cause the seat control apparatus to acquire driving information on a driving environment of a host vehicle. The instructions, when executed by the controller, may further cause the control apparatus to determine the control parameter when it is identified that an autonomous driving control for the host vehicle is possible based on the driving information.

In an embodiment, the instructions, when executed by the controller, may cause the seat control apparatus to determine a first slide movement amount of the rear seat based on the first body information acquired by using the sensor part. The instructions, when executed by the controller, may further cause the control apparatus to determine at least one of a second slide movement amount of the front seat, a movement amount of a steering wheel, or a combination thereof, based on the second body information stored in the memory.

In an embodiment, the instructions, when executed by the controller, may cause the seat control apparatus to identify information including at least one of a seating location, a seating posture, a seating direction, a volume of the rear seat passenger, or any combination thereof, based on the first body information. The instructions, when executed by the controller, may further cause the control apparatus to determine the swivel direction with respect to the front seat based on the identified information.

In an embodiment, the seat control apparatus may further include an output part. The instructions, when executed by the controller, may cause the seat control apparatus to provide the user with the seat control information including a predicted control result for the front seat and the rear seat by using the output part. The instructions, when executed by the controller, may further cause the control apparatus to control the front seat and the rear seat based on the control parameter by using the driving part when receiving an approval input corresponding to the seat control information from the user.

According to another aspect of the present disclosure, a seat control method is provided. The seat control method includes identifying, by a controller, whether a state of a rear seat passenger correspond to a first specified state when it is identified by using a sensor part that the rear seat passenger is seated on a rear seat. The seat control method also includes identifying, by the controller, whether a state of a user seated on a front seat corresponds to a second specified state indicative of carelessness when the rear seat passenger seated on the rear seat is in the first specified state. The seat control method additionally includes determining, by the controller, a control parameter including at least one of a slide movement amount of the front seat, a slide movement among of the rear seat, a swivel direction of the front seat, or a combination thereof, based on first body information of the rear seat passenger and second body information of the user when the user is in the second specified state. The seat control method further includes providing, by the controller, the user with seat control information including the determined control parameter.

In an embodiment, identifying whether the state of the rear seat passenger corresponds to the first specified state when it is identified by using the sensor part that the rear seat passenger is seated on the rear seat may include identifying, by the controller, that the state of the rear seat passenger corresponds to the first specified state when it is identified that care is required for the rear seat passenger based on information on a feeling state of the rear seat passenger acquired by using the sensor part.

In an embodiment, identifying whether the state of the rear seat passenger corresponds to the first specified state when it is identified by using the sensor part whether the rear seat passenger is seated on the rear seat may include identifying, by the controller, that the state of the rear seat passenger corresponds to the first specified state when it is identified that the rear seat passenger is a child of a specific age or less based on the first body information of the rear seat passenger acquired by using the sensor part.

In an embodiment, identifying whether the state of the user seated on the front seat corresponds to the second specified state indicative of carelessness may include identifying, by the controller, that the state of the user corresponds to the second specified state when it is identified that the user is in a carelessness state based on gaze information of the user acquired by using the sensor part.

In an embodiment, determining the control parameter may include acquiring, by the controller, driving information on a driving environment of a host vehicle. Determining the control parameter may also include determining, by the controller, the control parameter when identifying based on the driving information that an autonomous driving control for the host vehicle is allowed.

In an embodiment, determining the control parameter may include determining, by the controller, a first slide movement amount of the rear seat based on the first body information acquired by using the sensor part. Determining the control parameter may also include determining, by the controller, at least one of a second slide movement amount of the front seat, a movement amount of a steering wheel, or a combination thereof, based on the second body information stored in the memory.

In an embodiment, determining the control parameter may include identifying, by the controller, information including at least one of a seating location, a seating posture, a seating direction, a volume of the rear seat passenger, or a combination thereof, based on the first body information. Determining the control parameter may also include determining, by the controller, the swivel direction with respect to the front seat based on the identified information.

According to another aspect of the present disclosure, a computer readable storage medium is provided having instructions stored thereon. The instructions, when executed by at least one processor, cause the at least one processor to perform operations. The operations include identifying whether a state of a rear seat passenger corresponds to a first specified state when it is identified by using a sensor part that the rear seat passenger is seated on a rear seat. The operations also include identifying whether a state of a user seated on a front seat corresponds to a second specified state indicative of carelessness when the passenger seated on the rear seat is in the first specified state. The operations additionally include determining a control parameter including at least one of a slide movement amount of the front seat, a slide amount of the rear seat, a swivel direction of the front seat, or a combination thereof, based on first body information of the rear seat passenger and second body information of the user when the user is in the second specified state. The operations further include providing the user with seat control information including the determined control parameter.

In an embodiment, identifying whether the state of the rear seat passenger corresponds to the first specified state when it is identified by using the sensor part whether the rear seat passenger is seated on the rear seat may include identifying that the state of the rear seat passenger corresponds to the first specified state when it is identified that care is required for the rear seat passenger based on information on a feeling state of the rear seat passenger acquired by using the sensor part.

In an embodiment, identifying whether the state of the rear seat passenger corresponds to the first specified state when it is identified by using the sensor part that the rear seat passenger is seated on the rear seat may include identifying that the state of the rear seat passenger corresponds to the first specified state when it is identified that the rear seat passenger is a child infant of a specific age or less based on the first body information of the rear seat passenger acquired by using the sensor part.

In an embodiment, identifying whether the state of the user seated on the front seat is the second specified state indicative of carelessness may include identifying that the state of the user corresponds to the second specified state when it is identified that the user is in a carelessness state based on gaze information of the user acquired by using the sensor part.

In an embodiment, determining the control parameter may include acquiring driving information on a driving environment of a host vehicle. Determining the control parameter may also include determining the control parameter when identifying based on the driving information that an autonomous driving control for the host vehicle is allowed.

### BRIEF DESCRIPTION OF THE DRAWINGS

The above and other objects, features, and advantages of the present disclosure should be more apparent from the following detailed description taken in conjunction with the accompanying drawings, in which:

FIG. 1 is a block diagram illustrating components of a seat control apparatus, according to an embodiment of the present disclosure;

FIG. 2 is a block diagram illustrating components of a seat control apparatus, according to another embodiment of the present disclosure;

FIG. 3 is a conceptual view illustrating an interior of a host vehicle, according to an embodiment of the present disclosure;

FIG. 4 is a conceptual view illustrating an operation of a seat control apparatus, according to an embodiment of the present disclosure;

FIG. 5 is a flowchart of a seat control method, according to an embodiment of the present disclosure;

FIG. 6 is a flowchart of a seat control method, according to another embodiment of the present disclosure; and

FIG. 7 illustrates a computing system related to a seat control apparatus and method, according to an embodiment of the present disclosure.

In the drawings, the same or similar reference numerals may be used for the same or similar components.

### DETAILED DESCRIPTION

Hereinafter, embodiments of the present disclosure are described in detail with reference to the accompanying drawings. In the accompanying drawings, the identical or equivalent components are designated by the identical numerals even when the components are illustrated in different drawings. Further, in the following description, where it has been considered that a detailed specific description of well-known features or functions may unnecessarily obscure the gist of the present disclosure, a detailed description thereof has been omitted.

In describing the components of the embodiment according to the present disclosure, terms such as first, second, “A”, “B”, (a), (b), and the like may be used. These terms are merely intended to distinguish one component from another component. The terms do not limit the nature, sequence, or order of the constituent components. Unless otherwise defined, all terms used herein, including technical or scientific terms, have the same meanings as those generally understood by those having ordinary skill in the art to which the present disclosure pertains. Such terms as those defined in a generally used dictionary should be interpreted as having meanings consistent with the contextual meanings in the relevant field of art. The terms should not be interpreted as having ideal or excessively formal meanings unless clearly defined as having such in the present disclosure.

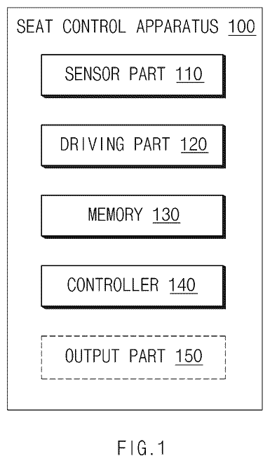

Hereinafter, embodiments of the present disclosure are described in detail with reference to FIGS. 1-7. In the following description, when a component, device, element, or the like of the present disclosure is described as having a purpose or performing an operation, function, or the like, the component, device, or element should be considered herein as being “configured to” meet that purpose or perform that operation or function. Each component, device, element, and the like may separately embody or be included with a processor and a memory, such as a non-transitory computer readable media, as part of the apparatus.

FIG. 1 is a block diagram illustrating components of a seat control apparatus, according to an embodiment of the present disclosure.

According to an embodiment, a seat control apparatus 100 may include at least one of a sensor part 110, a driving part 120, a memory 130, a controller 140, or any combination thereof. A configuration of the seat control apparatus 100 illustrated in FIG. 1 is illustrative, and embodiments in the present disclosure are not limited thereto. For example, the seat control apparatus 100 may further include components (e.g., at least one of an input part, an interface part, a communication part, a notification part, or any combination thereof) that are not illustrated in FIG. 1.

According to an embodiment, the sensor part 110 may include at least one sensor that acquires (or identifies) various information on a driving state of a host vehicle and/or a state of a seat.

For example, the sensor part 110 may acquire driving information on the driving state of the host vehicle. The driving information may include information on the autonomous driving control. As an example, the driving information may include information on the autonomous driving control including information on an automated lane keeping system (ALKS) operation history and information on a front/rear/side collision avoidance assistance system operation history. The controller 140 may identify, based on the driving information, whether an autonomous driving control for the host vehicle is possible, for example.

As another example, the sensor part 110 may include at least one sensor (e.g., at least one of a passenger sensing sensor, a pressure sensor, a camera, or any combination thereof) that identifies whether a user is seated on a seat in the host vehicle. The controller 140 may identify in real time whether the user is seated on each seat included in the host vehicle by using the at least one sensor.

For example, the sensor part 110 may acquire (or identify) information on at least one passenger seated in an interior of the host vehicle.

As an example, the sensor part 110 may acquire information (e.g., gaze information) on the user seated in a front seat (or a seat of row 1 including the driver's seat and a first-row passenger seat) of the host vehicle. The controller 140 may identify whether the user is in a carelessness state based on the information on the user.

As another example, the sensor part 110 may acquire information (e.g., body information) on a rear seat passenger seated on the rear seat (or a seat of row 2 in the rear of the driver's seat and the first-row passenger seat). The information on the rear seat passenger may include body information (e.g., an age, a volume, a seating location, a seating direction, a seating posture, or any combination thereof) of the rear seat passenger. The information on the rear seat passenger may include information on a feeling state (e.g., a crying state or a smiling state) of the rear seat passenger.

According to an embodiment, the driving part 120 may be configured to adjust a location of the seat.

For example, the driving part 120 may include at least one driving device (e.g., at least one motor) that adjusts at least one of a reclining angle, a slide location, a headrest angle, a leg rest angle, a swivel angle of the seat, or any combination thereof.

For example, the controller 140 may perform a slide control for moving the front seat and/or rear seat forwards or rearwards by using the driving part 120. As another example, the controller 140 may perform a swivel control for rotating the front seat and/or the rear seat at a specified angle within 360 degrees relative to a vertical axis by using the driving part 120.

According to an embodiment, the memory 130 may store commands and/or data. For example, the memory 130 may store one or more instructions that, when executed by the controller 140, cause the seat control apparatus 100 to perform various operations.

In an example, the memory 130 and the controller 140 may be implemented as one chipset. The controller 140 may include at least one of a communication processor or a modem.

The memory 130 may store various information on the user. For example, the memory 130 may store body information (e.g., a weight, a height, a length of the upper body, a length of the lower body, etc.) of the user. The controller 140 may determine a slide movement amount for a slide control of the front seat and/or a steering wheel movement amount for facilitating a swivel control based on the body information of the user stored in the memory 130.

In an embodiment, the controller 140 may be operatively connected to at least one of the sensor part 110, the driving part 120, the memory 130, or any combination thereof. The controller 140 may control operation of at least one of the sensor part 110, the driving part 120, the memory 130, or any combination thereof.

The controller 140 may identify whether the rear seat passenger is seated on the rear seat by using the sensor part 110.

The controller 140 may, for example, identify whether a passenger is seated in an area of the rear seat by using various sensor devices (e.g., a camera, a pressure sensor mounted on the rear seat, an ultrasonic sensor, a rear occupant alert (ROA) sensor, or any combination thereof) included in the sensor part 110.

In an embodiment, the controller 140 may identify whether the state of the rear seat passenger is a first specified state.

For example, in response to identifying that the rear seat passenger is in a situation in which care is required for the rear seat passenger based on information on a feeling state of the rear seat passenger acquired by using the sensor part 110, the controller 140 may identify that the state of the rear seat passenger corresponds to the first specified state. The situations that require care may include, for example, a situation in which the rear seat passenger is crying, a situation in which it is identified that the seating location of the rear seat passenger is dangerous because it exceeds a specified range, a situation in which it is identified that the seating posture of the rear seat passenger falls within a specified posture and thus is dangerous, a situation in which it is identified that the seating direction of the rear seat passenger exceeds a specified direction range and thus is dangerous, or any combination thereof.

For example, the controller 140 may identify that the state of the rear seat passenger corresponds to the first specified state in response to identifying that the rear seat passenger is a child (e.g., an infant or a toddler) of a specified age or less based on first body information of the rear seat passenger acquired by using the sensor part 110. In other words, when identifying a situation that requires care, such as when the rear seat passenger is an infant or a toddler of a specified age or less and the rear seat passenger is currently in a dangerous state, the controller 140 may identify that the state of the rear seat passenger corresponds to the first specified state.

In an example, when the passenger seated in the rear seat is in the first specified state, the controller 140 may identify whether the state of the user seated in the front seat is in a second specified state indicative of carelessness.

As an example, the controller 140 may acquire gaze information of the user seated on the front seat by using at least one sensor device (e.g., a gaze sensing sensor) included in the sensor part 110. The controller 140 may identify the gaze direction of the user, whether the gaze has changed, an object corresponding to the gaze direction, and/or the like, based on the gaze information. The controller 140 may identify whether the user is in a carelessness state based on the identified information. The carelessness state may include a state (e.g., a state in which the gaze direction continuously faces a front side) in which the user does not recognize the state of the rear seat passenger. When it is identified that the user is in the carelessness state, the controller 140 may identify that the user is in the second specified state.

In an embodiment, when the rear seat passenger corresponds to the first specified state and the user corresponds to the second specified state, the controller 140 may determine a control parameter, including a slide movement amount of the front seat and the rear seat and a swivel direction of the front seat, based on the first body information of the rear seat passenger and second body information of the user.

The controller 140, as an example, may determine a first slide movement amount of the rear seat based on the first body information of the rear seat passenger acquired by using the sensor part 110. For example, when a body part (e.g., a leg) of the rear seat passenger protrudes beyond a cushion of the rear seat, the first slide movement amount by which a slide of the rear seat is moved to a rearmost location may be determined. As another example, when a leg of the rear seat passenger does not protrude beyond the cushion of the rear seat, the first slide movement amount may be determined such that a slide control of the rear seat is not performed.

In an example, the controller 140 may determine at least one of a second slide movement amount of the front seat or a movement amount of the steering wheel, or any combination thereof, based on the second body information of the user stored in the memory 130. The controller 140 may update and store the second body information by using the sensor part 110. For example, information including at least one of the seating location, seating posture, the seating direction, the volume of the rear seat passenger, or any combination thereof may be identified based on the first body information, and a swivel direction for the front seat may be determined based on the identified information. The controller 140, for example, may determine the swivel direction (e.g., clockwise or counterclockwise direction) of the front seat based on the seating location and/or the seating direction of the rear seat passenger to control the state of the seat such that the user may approach the rear seat passenger more easily when the swivel operation is ended. The controller 140, for example, may predict, based on a body size of the user, or the like, whether the steering wheel will collide with the body of the user when the front seat is swiveled. In this case, when expecting that the steering wheel will collide with the body of the user, the controller 140 may determine the movement amount of the steering wheel by which the steering wheel may be moved forwards to perform a swivel control more easily and safely.

In an example, the controller 140 may determine a control parameter only when the host vehicle allows an autonomous driving control. For example, the controller 140 may acquire driving information on the driving environment of the host vehicle by using the sensor part 110. The controller 140 may then determine the control parameter when it is identified, based on the driving information, that an autonomous driving control for the host vehicle is possible.

The controller 140 may provide the user with seat control information including determined control parameters.

The controller 140, as an example, may provide the user with the seat control information including an expected control result for the front seat and the rear seat. In other words, when the control parameters are determined, the controller 140 may provide the user with seat control information including the expected seat control process and a control result when control is performed based on the control parameter. The controller 140 may provide the user with the seat control information through visual and/or auditory contents by using an output part 150.

In an example, in response to receiving an approval input corresponding to the seat control information from the user, the controller 140 may control the front seat and/or the rear seat based on the control parameter by using the driving part 120. For example, when receiving the approval input of the user, the controller 140 may perform a swivel control and/or a slide movement control for the front seat and/or the rear seat based on the determined control parameter. Additionally, when receiving the approval input of the user, the controller 140 may move the steering wheel forwards to safely and easily perform the swivel control for the front seat.

According to an embodiment, the output part 150 may include a display device and/or an audio output device.

The controller 140 may provide the user with various information on a seat control by using the output part 150.

For example, the controller 140 may provide the user with seat control information including an expected control result for the front seat and the rear seat through visual content by using the display device.

Additionally, or alternatively, the controller 140 may provide the user with seat control information including an expected control result for the front seat and the rear seat through auditory contents by using the audio output device.

The components of the seat control apparatus 100 illustrated in FIG. 1 are illustrative, and embodiments of the present disclosure are not limited thereto. For example, the seat control apparatus 100 may further include at least one of a switch (not illustrated), a communication part (not illustrated), an interface (not illustrated), or any combination thereof.

In an example, when receiving a user input (e.g., a touch input) for a switch, the controller 140 may identify that an approval input for the seat control has been received.

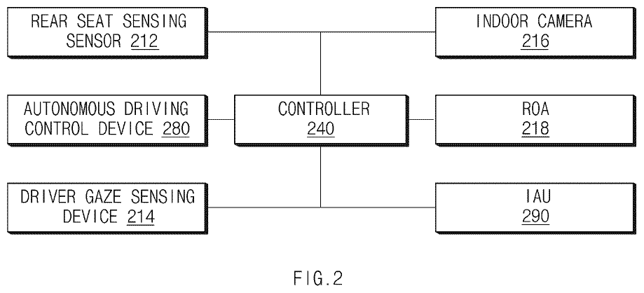

FIG. 2 is a block diagram illustrating components of the seat control apparatus, according to an embodiment of the present disclosure.

According to an embodiment, the seat control apparatus (e.g., the seat control apparatus 100 of FIG. 1) may include at least one of a rear seat passenger sensing sensor 212, a driver gaze sensing device (or, a driver gaze sensing sensor) 214, an indoor camera 216, an ROA 218, a controller 240 (e.g., the controller 140 of FIG. 1), an autonomous driving control device 280, an identity authentication unit (IAU) 290, or any combination thereof.

In an embodiment the rear seat passenger sensing sensor 212, the driver gaze sensing device 214, the indoor camera 216, and the ROA 218 are independent components as illustrated in FIG. 2. In other examples, one or more of the rear seat passenger sensing sensor 212, the driver gaze sensing device 214, the indoor camera 216, and the ROA 218 may be implemented by integrating them within one device (e.g., the sensor part 110 of FIG. 1).

The controller 240 may be operatively connected to the rear seat passenger sensing sensor 212, the driver gaze sensing device 214, the indoor camera 216, the ROA 218, the autonomous driving control device 280, and/or the IAU 290.

The controller 240 may identify whether a passenger is seated on the rear seat by using at least one of the rear seat passenger sensing sensor 212, the indoor camera 216, the ROA 218, or any combination thereof.

For example, the controller 240 may identify first body information of the rear seat passenger by using at least one of the rear seat passenger sensing sensor 212, the indoor camera 216, the ROA 218, or any combination thereof. The first body information, for example, may include at least one of a body size, a volume, a weight, a body temperature, an age, a feeling state, a seating posture, a seating location, a seating direction of the rear seat passenger, or any combination thereof.

The controller 240 may also identify second body information of the user seated on the front seat by using the driver gaze sensing device 214 and/or the indoor camera 216. The second body information, for example, may include at least one of a body size, a volume, a weight, a body temperature, a gaze of the user, or any combination thereof. The controller 240 may identify whether the user is in a carelessness state by using the second body information.

In an example, the controller 240 may identify whether an autonomous driving control for the host vehicle is possible based on the driving information of the host vehicle acquired through the autonomous driving control device 280.

The controller 240 may identify whether a person seated on the front seat is the user corresponding to the second body information stored in a memory (e.g., the memory 130 in FIG. 1), by using the IAU 290.

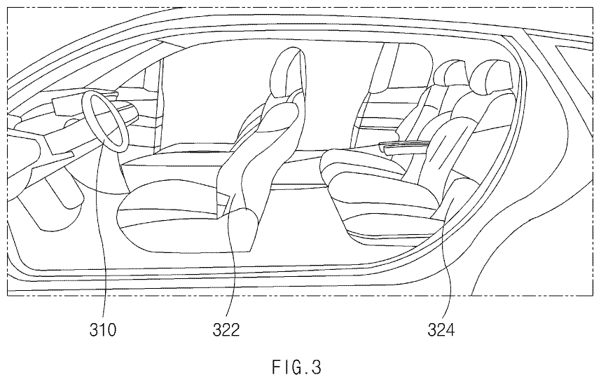

FIG. 3 is a conceptual view illustrating an interior of the host vehicle, according to an embodiment of the present disclosure.

According to an embodiment, the host vehicle may include at least one seat 322, 324 and a steering wheel 310 in the interior thereof.

In an example, the host vehicle may include a front seat 322 and a rear seat 324.

The front seat 322 may include at least one seat including the driver's seat and/or a first-row passenger seat in the same row as the driver's seat.

The rear seat 324 may include at least one seat that is disposed on a rear side of each of the driver's seat and/or the first-row passenger seat.

In an example, the seat control apparatus (e.g., the seat control apparatus 100 of FIG. 1) may determine a slide movement amount for a slide control for the front seat 322 and/or the rear seat 324 based on whether at least one specified condition is satisfied.

For example, when the size of the rear seat passenger seated on the rear seat 324 is larger than a specified size (e.g., when a part of the body of the passenger of the rear seat passenger protrudes beyond the cushion of the rear seat), the seat control apparatus may identify a slide movement amount by which the rear seat is moved further rearwards.

In an example, the seat control apparatus may determine, based on the body information of the user seated on the front seat 322, a movement amount of the steering wheel 310 to more easily and safely perform swivel control of the front seat 322.

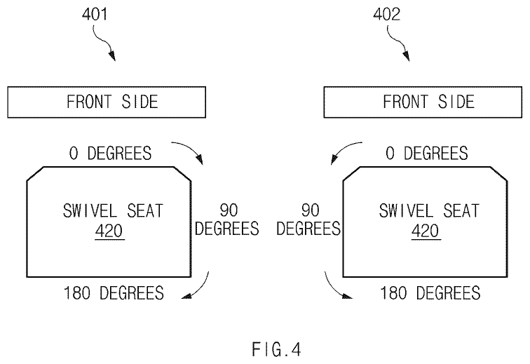

FIG. 4 is a conceptual view illustrating an operation of the seat control apparatus, according to an embodiment of the present disclosure.

Referring to a view 401, according to an embodiment, the seat control apparatus (e.g., the seat control apparatus 100 of FIG. 1) may perform a swivel control for a swivel seat 420 clockwise.

For example, the seat control apparatus may rotate the swivel seat 420 clockwise with respect to the direction that faces the front side of the vehicle.

In an example, when it is identified that the rear seat passenger is seated on a right rear area of the user seated on the swivel seat 420 with respect to the direction that faces the front side, the seat control apparatus may rotate the swivel seat 420 clockwise by a specified angle within 180 degrees.

Referring now to a view 402, according to an embodiment, the seat control apparatus may perform the swivel control for the swivel seat 420 counterclockwise.

For example, the seat control apparatus may rotate the swivel seat 420 counterclockwise with respect to the direction that faces the front side of the vehicle.

In an example, when it is identified that the rear seat passenger is seated on a left rear area of the user seated on the swivel seat 420 with respect to the direction that faces the front side, the seat control apparatus may rotate the swivel seat 420 counterclockwise by a specified angle within 180 degrees.

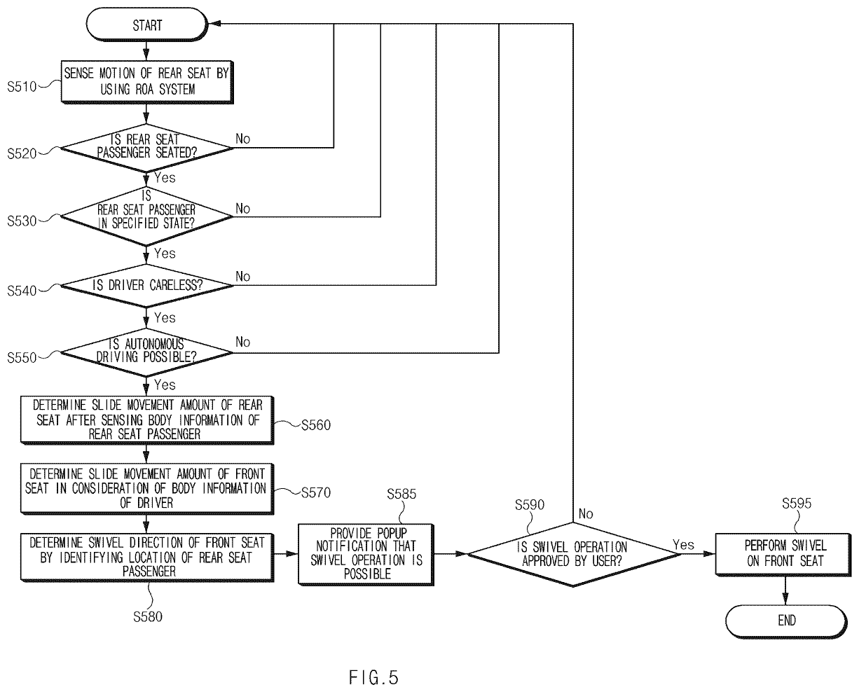

FIG. 5 is a flowchart of a seat control method, according to an embodiment of the present disclosure.

According to an embodiment, the seat control apparatus (e.g., the seat control apparatus 100 of FIG. 1) may perform the operations illustrated in FIG. 5. For example, at least some of the components included in the seat control apparatus (e.g., the sensor part 110, the driving part 120, the memory 130, the controller 140, and the output part 150 of FIG. 1) may be configured to perform the operations of FIG. 5.

In some embodiments, operations S510-S595 may be performed sequentially as illustrated in FIG. 5. However, the operations S510-S595 need not necessarily be performed sequentially as illustrated in FIG. 5. For example, a sequence of the operations may be changed and/or at least two operations may be performed in parallel. It should be noted that contents that correspond to, or overlap with, the contents described above may be briefly described below in relation to FIG. 5 or may be omitted from the description of FIG. 5.

In an operation S510, the seat control apparatus may sense a motion in an area including the rear seat by using the ROA system.

For example, the seat control apparatus may identify whether a motion is sensed in the rear seat area by using the ROA system.

In an operation S520, when a motion is sensed, the seat control apparatus may identify whether a passenger is seated on the rear seat.

When a passenger is seated on the rear seat (Yes in the operation S520), the seat control apparatus may perform an operation S530.

On the other hand, when there is no passenger seated on the rear seat (No in the operation S520), the seat control apparatus may end operation.

In the operation S530, the seat control apparatus may identify whether a state of the rear seat passenger corresponds to a specified state.

For example, the seat control apparatus may identify whether the rear seat passenger is crying based on the feeling state of the rear seat passenger.

As another example, the seat control apparatus may identify whether the rear seat passenger is a child (e.g., an infant or a toddler) of a specified age or less based on acquisition of the body information of the rear seat passenger.

When the rear seat passenger is in the specified state (Yes in the operation S530), the seat control apparatus may perform an operation S540.

On the other hand, when the rear seat passenger does not correspond to the specified state (No in the operation S530), the seat control apparatus may end operation.

In the operation S540, the seat control apparatus may identify whether the driver (or the user) is in a carelessness state.

For example, the seat control apparatus may identify whether the driver is currently in a carelessness state based on the gaze information of the driver.

When the driver is in a carelessness state (Yes in the operation S540), the seat control apparatus may perform an operation S550.

On the other hand, when the driver is not in a carelessness state (No in the operation S540), the seat control apparatus may end operation.

In the operation S550, the seat control apparatus may identify whether autonomous driving is possible.

For example, the seat control apparatus may identify whether an autonomous driving control of the host vehicle is possible based on the driving information acquired through the sensor part.

When an autonomous driving control is possible (Yes in the operation S550), the seat control apparatus may perform an operation S560.

On the other hand, when an autonomous driving control is not possible (No in the operation S550), the seat control apparatus may end operation.

In the operation S560, the seat control apparatus may determine the slide movement amount for the rear seat after sensing body information of the rear seat passenger.

For example, when a part of the body of the rear seat passenger protrudes beyond the cushion of the rear seat, the seat control apparatus may determine the slide movement amount for moving the rear seat rearwards as being larger.

In an operation S570, the seat control apparatus may determine the slide movement amount for the front seat based on the information of the body of the driver.

For example, the seat control apparatus may determine the slide movement amount of the front seat based on the information of the body of the driver stored in memory. The seat control apparatus may determine the slide movement amount for the front seat such that the slide movement amount corresponds to a distance that allows the driver to more easily approach the rear seat passenger when the swivel control for the front seat is ended.

In an operation S580, the seat control apparatus may determine the swivel direction of the front seat by identifying the location of the rear seat passenger.

For example, the seat control apparatus may determine the swivel direction of the front seat as the counterclockwise direction when it is identified that the rear seat passenger is seated on a left rear side of the driver with respect to the front side of the host vehicle.

As another example, the seat control apparatus may determine the swivel direction of the front seat as the clockwise direction when it is identified that the rear seat passenger is seated on a rear right of the driver with respect to the front side of the host vehicle.

In an operation S585, the seat control apparatus may provide a pop-up notification that the swivel operation is possible.

For example, the seat control apparatus may provide the user with a pop-up notification including information that a swivel operation is possible through an output part. The pop-up notification, for example, may include information on a process of controlling the front seat and/or the rear seat based on control parameters determined by the seat control apparatus and a predicted control result.

In an operation S590, the seat control apparatus may identify whether a user approval for the swivel operation is received.

For example, the seat control apparatus may identify whether an approval input (e.g., a touch input and/or a voice input) is received from the user in response to the seat control information that is output through the output part.

When the user approval for the swivel operation is received (Yes in the operation S590), the seat control apparatus may perform an operation S595.

On the other hand, when the user approval for the swivel operation is not received (No in the operation S590), the seat control apparatus may end operation.

In the operation S595, the seat control apparatus may perform a swivel control for the front seat.

For example, the seat control apparatus may control the slide movement of the front seat and/or the rear seat while performing the swivel control for the front seat.

As another example, the seat control apparatus may move the steering wheel forwards to prevent the driver from colliding with the steering wheel during the swivel control process.

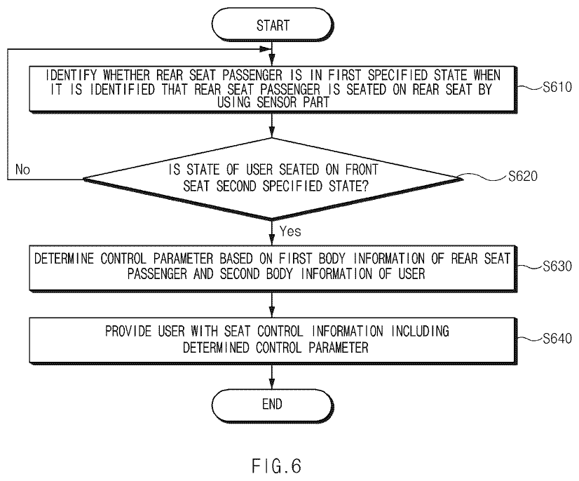

FIG. 6 is a flowchart of a seat control method, according to an embodiment of the present disclosure.

According to an embodiment, the seat control apparatus (e.g., the seat control apparatus 100 of FIG. 1) may perform the operations disclosed in FIG. 6. For example, at least some of the components included in the seat control apparatus (e.g., the sensor part 110, the driving part 120, the memory 130, the controller 140, and the output part 150 of FIG. 1) may be configured to perform the operations of FIG. 6.

In some embodiments, operations S610-S640 may be performed sequentially as illustrated in FIG. 6. However, the operations S610-S640 need not necessarily be performed sequentially as illustrated in FIG. 6. For example, a sequence of the operations may be changed and/or at least two operations may be performed in parallel. It should be noted that contents that correspond to, or overlap with, the contents described above may be briefly described with reference to FIG. 6 or may be omitted from the description of FIG. 6.

In an operation S610, when identifying that the rear seat passenger is seated on the rear seat by using the sensor part, the seat control apparatus may identify whether the rear seat passenger is in a first specified state.

For example, the first specified state may include a state in which the rear seat passenger is crying and is a child (e.g., an infant or a toddler) of a specified age or less.

In an operation S620, the seat control apparatus may identify whether the state of the user seated on the front seat is a second specified state.

For example, the second specified state may include a situation in which it is determined that the user is in a carelessness state based on the gaze information of the user.

When the state of the user is the second specified state (Yes in the operation S620), the seat control apparatus may perform an operation S630.

On the other hand, when the state of the user is not the second specified state (No in the operation S620), the seat control apparatus may end operation.

In the operation S630, the seat control apparatus may determine a control parameter based on first body information of the rear seat passenger and second body information of the user.

For example, the control parameter may include the swivel direction, the swivel movement amount, and/or the slide movement amount of the front seat.

As another example, the control parameter may include the slide movement amount of the rear seat.

As yet another example, the control parameter may include a steering wheel movement amount.

In an operation S640, the seat control apparatus may provide the user with the seat control information including the determined control parameter.

For example, the seat control apparatus may provide the user with the seat control information including the expected control result for the front seat and the rear seat through visual contents and/or auditory contents.

In an example, when receiving an approval input corresponding to the seat control information from the user, the seat control apparatus may control the front seat and the rear seat based on the control parameter using the driving part.

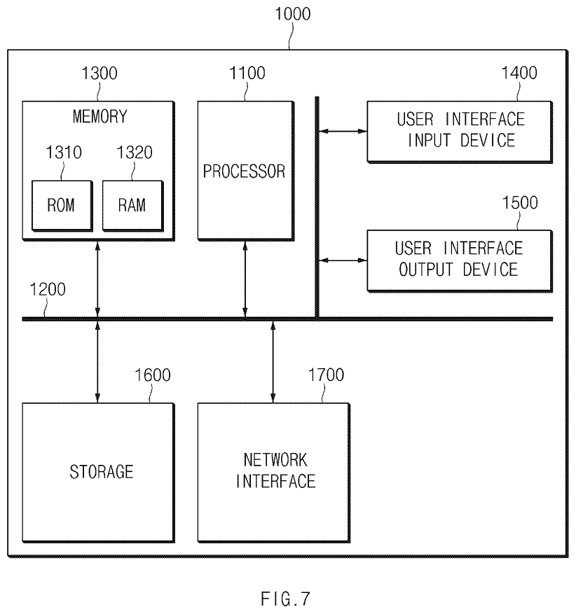

FIG. 7 illustrates a computing system configured to implement the seat control apparatus and method, according to an embodiment of the present disclosure.

Referring to FIG. 7, a computing system 1000 may include at least one processor 1100, a memory 1300, a user interface input device 1400, a user interface output device 1500, storage 1600, and a network interface 1700. The at least one processor 1100, the memory 1300, the user interface input device 1400, the user interface output device 1500, the storage 1600, and/or the network interface 1700 may be interconnected through a bus 1200.

The processor 1100 may be a central processing unit (CPU), or a semiconductor device that processes instructions stored in the memory 1300 and/or the storage 1600. The memory 1300 and the storage 1600 may include various volatile or nonvolatile storage media. For example, the memory 1300 may include a read only memory (ROM) and a random access memory (RAM).

Accordingly, the steps of the method or algorithm described in relation to the embodiments of the present disclosure may be implemented directly by hardware executed by the processor 1100, a software module, or a combination thereof. The software module may reside in a storage medium (e.g., the memory 1300 and/or the storage 1600), such as a RAM, a flash memory, a ROM, an EPROM, an EEPROM, a register, a hard disk, a solid state drive (SSD), a detachable disk, or a CD-ROM.

The storage medium may be coupled to the processor 1100. The processor 1100 may read information from the storage medium and may write information in the storage medium. In another example, the storage medium may be integrated with the processor 1100. The processor and the storage medium may reside in an application specific integrated circuit (ASIC). The ASIC may reside in a user terminal. In another example, the processor and the storage medium may reside in the user terminal as individual components.

The effects of the seat control apparatus and method according to embodiments of the present disclosure are as follows.

According to embodiments of the present disclosure, an emergency situation may be quickly recognized by providing the user with a pop-up notification that the front seat is to be swiveled by using the seat control apparatus, for example in a situation in which the user seated on the front seat does not clearly recognize a situation of the rear seat passenger (e.g., an infant or a toddler) seated on the rear seat.

Embodiments of the present disclosure provide a seat control apparatus and method that may store body information of the user in a memory. The seat control apparatus and method may determine movement amount of the front seat based on the body information stored in the memory when an emergency situation is identified.

Embodiments of the present disclosure may provide a seat control apparatus and method in which a swivel control of the front seat may be performed more easily by determining the movement amount of the steering wheel (i.e., an amount by which the steering wheel is to be moved) based on the body information of the user.

Embodiments of the present disclosure may provide a seat control apparatus and method in which convenient usage may be provided to the user by determining the swivel direction of the front seat based on the seating state (e.g., the seating location, the seating direction, the seating posture, and/or the volume) of the rear seat passenger.

In addition, various effects directly or indirectly recognized through the specification may be provided.

The above description is a simple illustrative description of the technical spirit of the present disclosure. The present disclosure may be variously modified and altered by a person having ordinary skill in the art to which the present disclosure pertains, without departing from the essential characteristics of the present disclosure.

Therefore, embodiments of the present disclosure are provided to explain the spirit and scope of the present disclosure, but not to limit them. The spirit and scope of the present disclosure is not limited by the embodiments. The scope of the present disclosure should be construed on the basis of the accompanying claims, and all the technical ideas within the scope equivalent to the claims should be included in the scope of the present disclosure.

What is claimed is:

1. A seat control apparatus, comprising:
a sensor part;
a driving part;
a memory configured to store one or more instructions; and
a controller operatively connected to the sensor part, the driving part, and the memory,
wherein the instructions, when executed by the controller, cause the seat control apparatus to
when it is identified by using the sensor part that a rear seat passenger is seated on a rear seat, identify whether a state of the rear seat passenger corresponds to a first specified state,
when the rear seat passenger seated on the rear seat is in the first specified state, identify whether a state of a user seated on a front seat corresponds to a second specified state indicative of carelessness of the user,
when the user is in the second specified state, determine a control parameter including at least one of a slide movement amount of the front seat, a slide movement of the rear seat, a swivel direction of the front seat, or a combination thereof, based on first body information of the rear seat passenger and second body information of the user, and
provide the user with seat control information including the determined control parameter.

2. The seat control apparatus of claim 1, wherein the instructions, when executed by the controller, cause the seat control apparatus to:
identify that the state of the rear seat passenger corresponds to the first specified state when it is identified that care is required for the rear seat passenger based on information on a feeling state of the rear seat passenger acquired by using the sensor part.

3. The seat control apparatus of claim 1, wherein the instructions, when executed by the controller, cause the seat control apparatus to:
identify that the state of the rear seat passenger corresponds to the first specified state when it is identified that the rear seat passenger is a child of a specific age or less based on the first body information of the rear seat passenger acquired by using the sensor part.

4. The seat control apparatus of claim 1, wherein the instructions, when executed by the controller, cause the seat control apparatus to:
identify that the state of the user corresponds to the second specified state when it is identified that the user is in a carelessness state based on gaze information of the user acquired by using the sensor part.

5. The seat control apparatus of claim 1, wherein the instructions, when executed by the controller, cause the seat control apparatus to:
acquire driving information on a driving environment of a host vehicle; and
determine the control parameter when it is identified that an autonomous driving control for the host vehicle is possible based on the driving information.

6. The seat control apparatus of claim 1, wherein the instructions, when executed by the controller, cause the seat control apparatus to:
determine a first slide movement amount of the rear seat based on the first body information acquired by using the sensor part; and
determine at least one of a second slide movement amount of the front seat, a movement amount of a steering wheel, or a combination thereof, based on the second body information stored in the memory.

7. The seat control apparatus of claim 1, wherein the instructions, when executed by the controller, cause the seat control apparatus to:
identify information including at least one of a seating location, a seating posture, a seating direction, a volume of the rear seat passenger, or a combination thereof, based on the first body information; and
determine the swivel direction of the front seat based on the identified information.

8. The seat control apparatus of claim 1, further comprising an output part, wherein the instructions, when executed by the controller, further cause the seat control apparatus to:
provide the user with the seat control information including a predicted control result for the front seat and the rear seat by using the output part; and
control the front seat and the rear seat based on the control parameter by using the driving part when receiving an approval input corresponding to the seat control information from the user.

9. A seat control method, comprising:
identifying, by a controller, whether a state of a rear seat passenger corresponds to a first specified state when it is identified by using a sensor part that the rear seat passenger is seated on a rear seat;
identifying, by the controller, whether a state of a user seated on a front seat corresponds to a second specified state indicative of carelessness of the user when the rear seat passenger seated on the rear seat is in the first specified state;
determining, by the controller, a control parameter including at least one of a slide movement amount of the front seat, a slide movement amount of the rear seat, a swivel direction of the front seat, or a combination thereof, based on first body information of the rear seat passenger and second body information of the user when the user is in the second specified state; and
providing, by the controller, the user with seat control information including the determined control parameter.

10. The seat control method of claim 9, wherein identifying whether the state of the rear seat passenger corresponds to the first specified state when it is identified by using the sensor part that the rear seat passenger is seated on the rear seat includes:
identifying, by the controller, that the state of the rear seat passenger corresponds to the first specified state when it is identified that care is required for the rear seat passenger based on information on a feeling state of the rear seat passenger acquired by using the sensor part.

11. The seat control method of claim 9, wherein identifying whether the state of the rear seat passenger corresponds to the first specified state when it is identified by using the sensor part whether the rear seat passenger is seated on the rear seat includes:
identifying, by the controller, that the state of the rear seat passenger corresponds to the first specified state when it is identified that the rear seat passenger is a child of a specific age or less based on the first body information of the rear seat passenger acquired by using the sensor part.

12. The seat control method of claim 9, wherein identifying whether the state of the user seated on the front seat corresponds to the second specified state indicative of carelessness includes:
identifying, by the controller, that the state of the user corresponds to the second specified state when it is identified that the user is in a carelessness state based on gaze information of the user acquired by using the sensor part.

13. The seat control method of claim 9, wherein determining the control parameter includes:
acquiring, by the controller, driving information on a driving environment of a host vehicle; and
determining, by the controller, the control parameter when identifying based on the driving information that an autonomous driving control for the host vehicle is allowed.

14. The seat control method of claim 9, wherein determining the control parameter includes:
determining, by the controller, a first slide movement amount of the rear seat based on the first body information acquired by using the sensor part; and
determining, by the controller, at least one of a second slide movement amount of the front seat, a movement amount of a steering wheel, or a combination thereof, based on the second body information stored in a memory.

15. The seat control method of claim 11, wherein determining the control parameter includes:
identifying, by the controller, information including at least one of a seating location, a seating posture, a seating direction, a volume of the rear seat passenger, or a combination thereof, based on the first body information; and
determining, by the controller, the swivel direction of the front seat based on the identified information.

16. A computer readable storage medium having instructions stored thereon that, when executed by at least one processor, cause at least one processor to perform operations including:
identifying whether a state of a rear seat passenger corresponds to a first specified state when it is identified by using a sensor part that the rear seat passenger is seated on a rear seat;
identifying whether a state of a user seated on a front seat corresponds to a second specified state indicative of carelessness when the rear seat passenger seated on the rear seat is in the first specified state;
determining a control parameter including at least one of a slide movement amounts of the front seat, a slide movement of the rear seat, a swivel direction of the front seat, or a combination thereof, based on first body information of the rear seat passenger and second body information of the user when the user is in the second specified state; and
providing the user with seat control information including the determined control parameter.

17. The computer readable storage medium of claim 16, wherein identifying whether the state of the rear seat passenger corresponds to the first specified state when it is identified by using the sensor part that the rear seat passenger is seated on the rear seat includes:
identifying that the state of the rear seat passenger corresponds to the first specified state when it is identified that care is required for the rear seat passenger based on information on a feeling state of the rear seat passenger acquired by using the sensor part.

18. The computer readable storage medium of claim 16, wherein identifying whether the state of the rear seat passenger corresponds to the first specified state when it is identified by using the sensor part that the rear seat passenger is seated on the rear seat includes:
identifying that the state of the rear seat passenger corresponds to the first specified state when it is identified that the rear seat passenger is a child of a specific age or less based on the first body information of the rear seat passenger acquired by using the sensor part.

19. The computer readable storage medium of claim 16, wherein identifying whether the state of the user seated on the front seat corresponds to the second specified state indicative of carelessness includes:
Identifying that the state of the user corresponds to the second specified state when it is identified that the user is in a carelessness state based on gaze information of the user acquired by using the sensor part.

20. The computer readable storage medium of claim 16, wherein determining the control parameter includes:
acquiring driving information on a driving environment of a host vehicle; and
determining the control parameter when identifying based on the driving information that an autonomous driving control for the host vehicle is allowed.
